(19) United States
(12) Patent Application Publication
(10) Pub. No.: US 2012/0148825 A1
(43) Pub. Date: Jun. 14, 2012

(54) METHOD OF PROCESSING POROUS ARTICLE AND POROUS ARTICLE

(75) Inventors: David Grosso, Cheptainville (FR); Mika Linden, Turku (FI)

(73) Assignee: COLIGRO OY, Helsinki (FI)

(21) Appl. No.: 13/375,536

(22) PCT Filed: Jun. 1, 2010
(86) PCT No.: PCT/FI2010/050442

§ 371 Date: Feb. 29, 2012

(30) Foreign Application Priority Data
Jun. 2, 2009 (FI) 20095616

(51) Int. Cl. B32B 3/26; B05D 3/02

(52) U.S. Cl. 428/305.5; 427/243

(57) ABSTRACT

A method and a porous article are provided. In said method, a porous article which comprises a matrix material in a solid state and pores therein, is processed at least some of the pores being open to an outer surface of the article. A flowing treatment substance is applied to the outer surface of the article and into at least some of the pores. The flowing treatment substance is allowed to react with the outer surface of the article and surfaces of said at least some of the pores such that a hydrophobic coating layer is established on surfaces thereof. An excess of the flowing treatment substance is removed from the article, and the hydrophobic coating layer established on the outer surface of the article is converted into a hydrophilic coating layer.

### FIELD OF THE INVENTION

The invention relates to a method of processing a porous article, said article comprising a matrix material in a solid state and pores therein, at least some of the pores being open to an outer surface of the article.

The invention further relates to a porous article, said article comprising a matrix material in a solid state and pores therein, at least some of the pores being open to an outer surface of the article.

### BACKGROUND OF THE INVENTION

Many stones, not to mention them all, have a porosity which one important reason for their degradability and aspect deterioration. The reason for this is that water as well as polluting and corrosive species can diffuse or adsorb inside the stone, thus potentially reducing its mechanical and chemical resistances.

Today, stone treatments are known wherein polymeric coatings are applied to the surface of a stone. The aim of the treatments is, primarily, to protect the surface and, secondly, to prevent any substance from penetrating into the porous network of the stone.

One of the problems associated with the above methods and treatments is that such coatings do not penetrate deep into the stone. The coatings are also easily altered due to their mechanical fragility and photo-induced degradability.

The wetting properties of solid surfaces and also of porous materials are of immense importance also in the field of construction materials. Porous construction materials, typical examples being concrete, sandstone and marble, can adsorb large amounts of water through condensation of water vapor from the air or through capillary suction of water from the soil or from, for example, deposited rain drops. This may lead to immense problems, such as degradation of wood in contact with the porous material, chemical degradation of the porous material itself through leaching and dissolution, through adsorption of acidic gases (for example NOₓ and SOₓ) creating acids when in contact with water, and through mechanical destruction of the porous material itself during freezing-melting cycles. It is needless to say that this creates substantial economical losses.

### BRIEF DESCRIPTION OF THE INVENTION

An object of the present invention is to provide a method and a porous article so as to alleviate the above disadvantages.

The method of the invention is characterized by applying a flowing treatment substance to the outer surface of the article and into at least some of the pores, the treatment substance comprising at least partially organic material, allowing the flowing treatment substance to react with the outer surface of the article and surfaces of said at least some of the pores such that a hydrophobic coating layer is established on surfaces thereof, removing excess flowing treatment substance from the article, and converting the hydrophobic coating layer established on the outer surface of the article into a hydrophilic coating layer.

The article of the invention is characterized in that it comprises a hydrophobic coating layer arranged on surfaces of at least some of the pores being open to the outer surface of the article and a hydrophilic coating layer on the outer surface of the article.

An idea of the invention is to apply a flowing treatment substance to the surfaces of the article and into at least some of the pores and allow the flowing treatment substance to react with the matrix material of the article such that a hydrophobic coating layer is established on the surfaces thereof, and convert the hydrophobic coating layer established on the outer surface of the article into a hydrophilic coating layer.

It is to be underlined here that in this description the term “flowing” means fluids and gaseous substances and that the term “treatment substance” means one-component fluid or one-component gaseous substance and any combinations of substances comprising liquid, gaseous and/or solid components.

An advantage of the method and the article of the invention is that water adsorption of the article may be reduced in a stable and long-lasting way.

The article may be hydrophobized either before or after the treatment step where a photoactive material or precursors thereof are arranged on the outer surface of the article. The surface of the article may be made more hydrophilic after hydrophobization by, for instance, mechanical polishing or heat treatments, more preferably local heat treatment of the surface, or utilizing the photoactivity of the photoactive material or precursors thereof.

### BRIEF DESCRIPTION OF THE DRAWINGS

In the following, the invention will be described in greater detail by means of preferred embodiments and with reference to the accompanying drawings, in which

FIG. 1 is a schematic side view of a part of a porous article to be treated with a method according to the invention,

FIG. 2 is a schematic side view of the part illustrated in FIG. 1 after a process step of the method according to the invention,

FIG. 3 is a schematic side view of the part illustrated in FIG. 1 after a second process step of the method according to the invention,

FIG. 4 is a schematic side view of the part illustrated in FIG. 1 after a third process step of the method according to the invention,

FIG. 5 is a schematic side view of the part illustrated in FIG. 1 after a fourth process step of the method according to the invention,

FIG. 6 is a schematic view of process steps of a method according to the invention,

FIG. 7 is a schematic view of further process steps of the method of FIG. 6,

FIGS. 8a to 8c are schematic views of process steps of a second method according to the invention,

FIG. 9 is a schematic view of a process line according to the invention,

FIG. 10 is a schematic view of a device according to the invention,

FIG. 11 is a schematic view of a third method according to the invention,

FIG. 12 is a schematic view of a fourth method according to the invention,

FIG. 13 is a schematic view of a second device according to the invention,

FIG. 14 is a schematic view of a third device according to the invention,

FIG. 15 is a schematic view of a fourth device according to the invention,

FIG. 16 is a schematic view of a fifth method and device according to the invention, and

FIG. 17 is a schematic view of a blocking function of a photoactive particle.

For the sake of clarity, the figures show the invention in a simplified manner. Like reference numbers identify like elements.

### DETAILED DESCRIPTION OF THE INVENTION

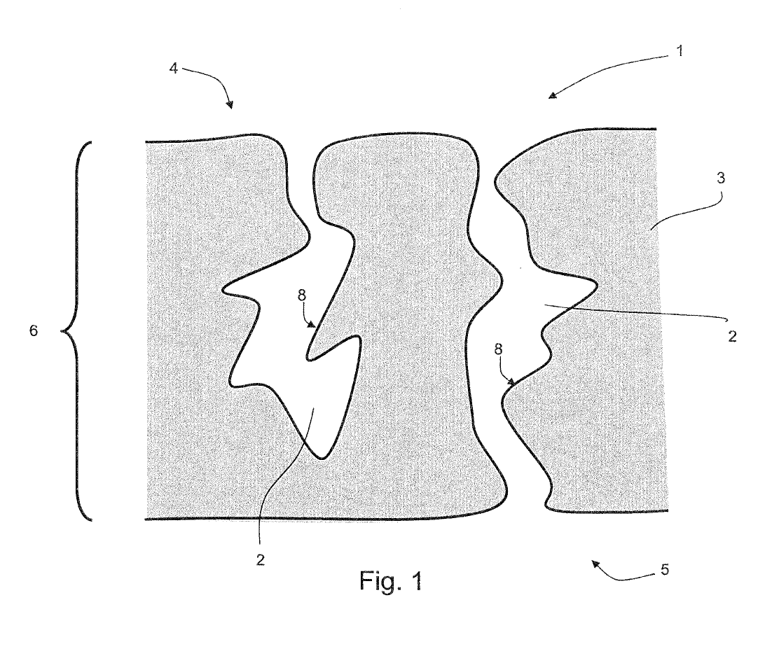

FIG. 1 is a schematic side view of a part of a porous article to be treated by a method according to the invention.

The article 1 is a sheet having a thickness 6 and made of natural stone. A matrix material 3 of natural stone materials is typically porous and, therefore, water and contaminants can easily penetrate into the stone or condense from a gas phase in the pores 2. Furthermore, the surfaces of natural stones are typically fairly rough, which provides further attachment sites for contaminants and water.

FIG. 1 shows how the pores 2 inside the matrix material 3 of the stone can form paths along which water can be transported through the body of the stone from a first outer surface 4 to a second outer surface 5 of the stone. It is obvious that dissolved acids, dirt, and other contaminants such as sulfur, sulfur oxides, nitrogen oxides, etc. can be transported into the stone 1, primarily with the water. As described above, there are stone qualities for which this is detrimental for the properties of the stone, marble being one example.

According to the invention, a flowing treatment substance is applied to an outer surface of the article 1 and into at least some of the pores 2. The treatment substance comprises at least a partially organic material and it is allowed to react with at least one of the first outer surface 4 and the second outer surface 5 of the article 1 and surfaces of said at least some of the pores 2 such that a hydrophobic coating layer is established on said surfaces. After removing a possible excess of the flowing treatment substance from the article 1, the hydrophobic coating layer established on the outer surface of the article is converted into a hydrophilic coating layer.

According to a preferred embodiment of the invention, the article 1 is treated such that the flowing treatment substance reaches and reacts with substantially all surfaces of the pores 2 open to at least one of the outer surfaces 4, 5 of the stone. As a result, the article 1 is hydrophobic and water-repellent over its whole thickness.

According to an embodiment of the invention, an organophosphate is allowed to adsorb onto both outer surfaces 4, 5 and the surfaces 8 of the pores from a fluid for making the article 1 water-repellent throughout the bulk of the material.

It is to be noted here that the natural stone may be, for instance, marble, calc stone, sand stone, granite, gneiss, limestone, sandstone, thermal stone, etc. Additionally, the article 1 may consist of concrete, cement, gypsum, tiles and any other ceramics. Furthermore, the article 1 may also be made from a powder-like or granulate material, such as plaster, in its native or already applied form. Thus, according to an embodiment of the invention, already installed joints or seams are treated. The treatment can thus be applied both before and/or after the installation of the article.

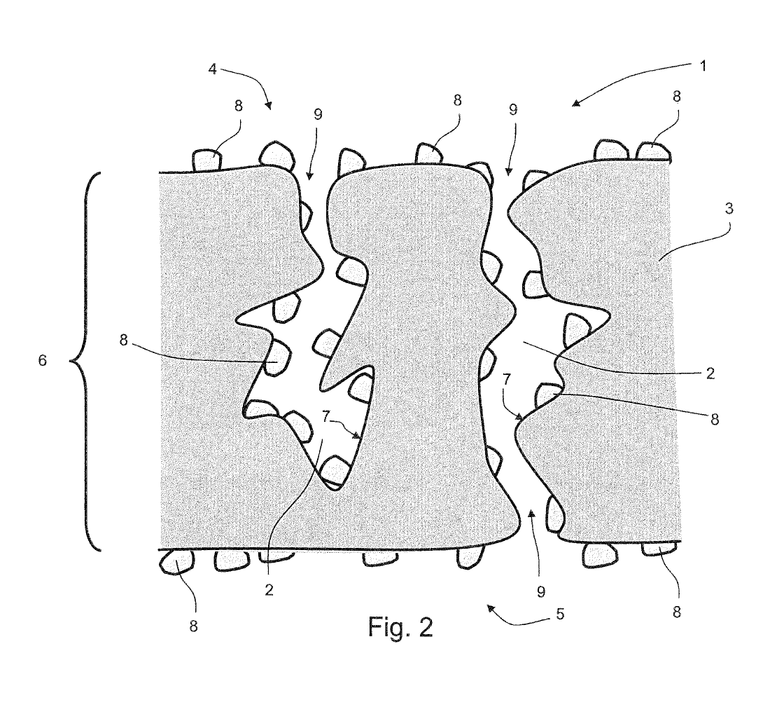

FIG. 2 is a schematic side view of the part illustrated in FIG. 1 after a process step of the method according to the invention.

Particles 8, which consist of a photoactive material, here titanium dioxide (TiO₂), are deposited not only onto the outer surfaces 4, 5 of the article 1 but also into at least a part of the inner porosity of the article 1. Said deposition is carried out by a wet processing method, for example by sol-gel methods, by impregnation of particulate sols, by pressure-driven impregnation, etc.

The primary function of the TiO₂ is to introduce a self-cleaning function into the article 1. Said function becomes activated as soon as TiO₂ is exposed to UV light. The portion of TiO₂ which is located inside the pores 2 is not activated by UV light, because it is not exposed to UV light. This non-activated portion may still be activated, i.e. exposed to UV light, during the service life of the article 1 because of mechanical wear or corrosion of the article 1. This way the outer surfaces of the article 1 will possess said self-cleaning function.

It is to be noted here that the photoactive material may be a UV light activated and/or a visible light activated material. The photoactive material may comprise TiO₂, Ag, CeO₂, TiO₂, MgTa₂O₆, ZnS, ZnO, SnO₂, BiVO₄ in a pure or a doped form or precursors or combinations thereof.

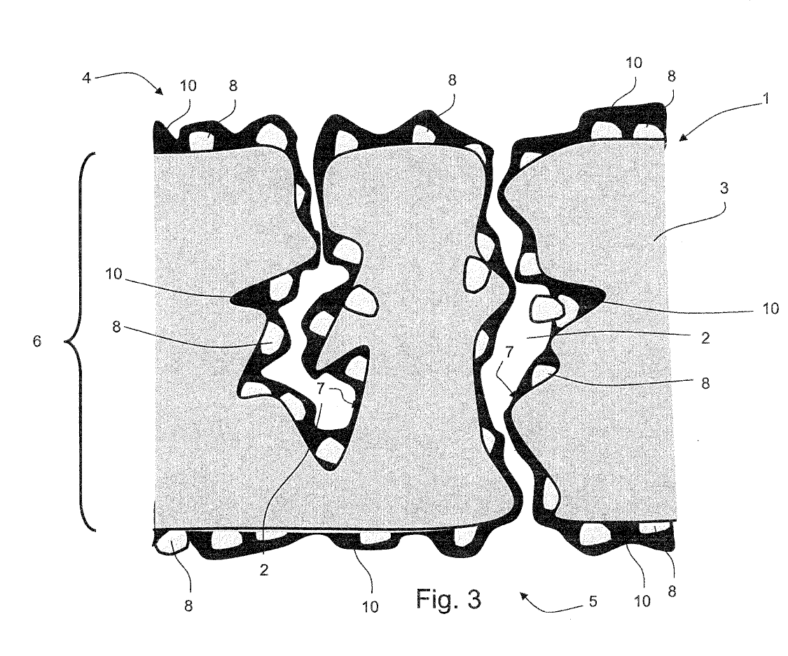

FIG. 3 is a schematic side view of the part illustrated in FIG. 1 after a second process step of the method according to the invention. In the second process step, the surfaces 7 of walls of the pores, including the surface with the TiO₂ particles, are at least partially covered with a layer of an organic material 10. In such a case, the organic material 10 is, for instance, an organophosphate. The phosphate group of the organophosphate attaches itself covalently or co-ordinatively to both CaCO₃ of the matrix material 3 (marble) and TiO₂.

The covalent attachment is a convenient way of hydrophobizing the surfaces of the article 1. Especially organic molecules with carbon chain lengths exceeding ten carbon atoms are effective surface hydrophobizing agents. There are several parameters affecting the extent of surface hydrophobization, among the most important being the carbon chain length, packing density on the surface, and the stability of the covalent bond between the organic molecule and the surface. Other important parameters include the presence or absence of polar groups in the organic moiety, and the degree of branching.

The organic molecule could have hydrocarbon, fluorocarbon, or a mixture of hydrocarbon and fluorocarbon groups in the chain. Typical examples of hydrophobization procedures utilizing the covalent attachment of organic groups to surfaces are thiol functionalization of gold and ZnO, aliphatic carboxylic acid or carboxylate functionalization of Al₂O₃, silanization of SiO₂, and organophosphate functionalization of TiO₂.

Phosphates (RO—PO₃²⁻), phosphonates (R—PO₃²⁻), phosphinic acid (RR′PO₂H) or corresponding salts where R, R′ are organic groups containing at least one carbon atom, e.g. —CH₃ or the like and other polyphosphates and polyphosphonates species, covalently or co-ordinatively incorporate themselves into many carbonates. The inventors have pressed amorphous CaCO₃ powders into tablets and observed that organic phosphates can be covalently incorporated into or/and onto the CaCO₃, making it hydrophobic as defined by a contact angle against water exceeding 90°.

According to an embodiment of the invention organic phosphates and/or phosphonates are dissolved in a solvent that can fully wet the porosity of marble, while they covalently attach to the marble surface, making it hydrophobic.

Examples of organic phosphates and phosphonates include, but are not limited to, fluorocarbons, hydrocarbons, mixtures of fluorocarbons and hydrocarbons, phospholipids, polymers containing phosphate or phosphonate groups, polymerizable smaller molecules including a phosphate and/or phosphonate group in at least one of the starting materials, chemical post-modifications of organic molecules introduced into or onto the article 1 where at least one of the molecules contains at least one phosphorus in its structure to form phosphate and/or phosphonate groups.

However, depending on the chemical nature of the article 1 or matrix material 3 and/or the particles present on the surfaces 4, 5, 7 of the article, other hydrophobization agents could be used as well. The organic molecule may also be, for instance, betadiketonate, thiol, silane, siloxane, and carboxylic acid or any salts of the corresponding acids or any mixtures of these.

The organic molecules may be adsorbed from a solution, where the solvent is preferably chosen so that it wets the surfaces 4, 5, 7 of the article, and so that the organic molecule(s) is/are at least partially soluble in the solvent.

Especially marble has turned out to be very susceptible to both chemical and mechanical degradation, because marble, mainly consisting of crystalline CaCO₃, easily converts to amorphous CaCO₃ that is mechanically very brittle under the influence of acids. This chemical degradation of marble makes freezing-melting cycles even more detrimental to the mechanical stability and integrity of marble. As result of making an article made of marble hydrophobic, the adsorption and penetration of water into the bulk of the marble is minimized and, thus, the lifetime of the article is increased especially in, but not limited to, outdoor use.

If TiO₂ particles have been adsorbed onto and/or into the article 1 before adsorption of the organic material, or simultaneously with it, the organic material will also bind to the TiO₂ particles and make the TiO₂ particles hydrophobic.

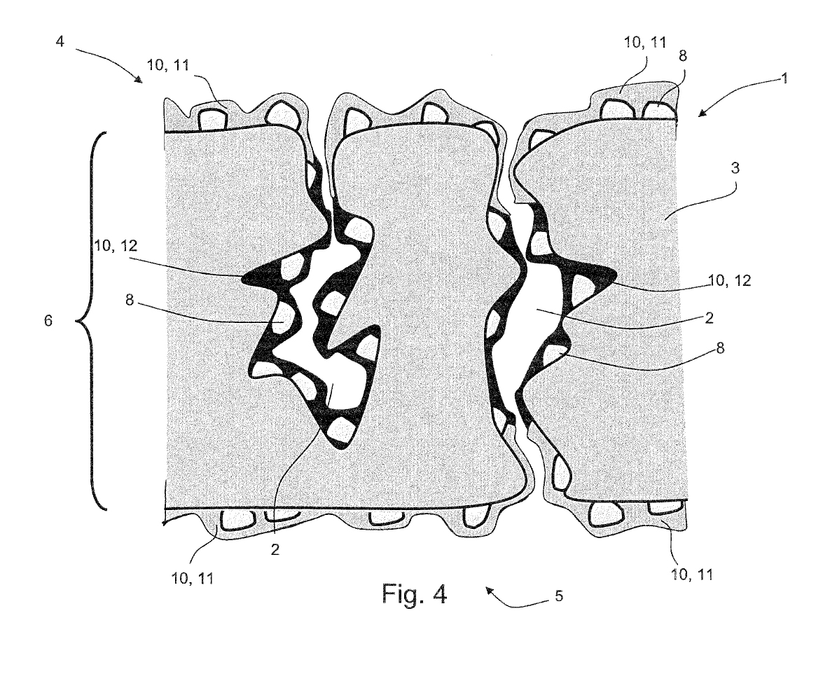

FIG. 4 is a schematic side view of the part illustrated in FIG. 1 after a third process step of the method according to the invention.

As discussed above, on to the outer surface of the article 1, and preferably also into the pores 2 of the article, a photoactive or photocatalytic material is introduced. It is known that some semiconductor oxides, such as TiO₂, N or P-doped TiO₂, MgTa₂O₆, SnO₂, or BiVO₄ have an ability to be exited by light radiations to create very reactive radical species at their surface upon recombination of excitons with atmospheric water and oxygen. When an organic contaminant deposits and lies at the vicinity of the photoactive material, a progressive decomposition of the contaminant into inertial CO₂ and H₂O takes place.

The above-mentioned phenomenon is known as a self cleaning function. It may be accomplished, for instance, by a solvent depositing the photoactive material or its precursor(s) on the outer surfaces 4, 5 and surfaces 7 of the pores of the article 1. For example, stabilized TiO₂ nanoscale or microscale particles, or molecular precursors of TiO₂, such as molecular TiX₄, wherein X═Cl⁻, Br⁻, I⁻, RO⁻, or NO₃⁻; or such as molecular TiX₃, wherein X═Cl⁻, Br⁻, I⁻, RO⁻, or NO₃⁻; or such as molecular TiX₂, wherein X═SO₄²⁻, CO₃²⁻, CO₂O₄²⁻, or combinations thereof or precondensed species, such as TiOCl₂ or TiOₓ(OR)_{y}(OH₂)_{z}, wherein R═H or an organic material of general formula CₙOₘNᵥH_{w}, e.g. —CH₃, —CH(CH₃)₂ or the like and wherein 2x+y=3 or 4 depending on the oxidation degree of Ti, dissolve or disperse into a solvent. A treatment substance comprising the solvent and the Ti-based species wets preferably the whole porosity or at least substantially all openstructured pores of the article 1. The Ti-based species precipitate inside the porosity and deposit onto the outer surfaces 4, 5 of the article 1 upon solvent evaporation.

Optionally, a mild thermal treatment of the article 1 for at least partial removal of water may be applied prior to application of the treatment substance.

Photocatalytic activities of marbles treated by the above process with TiO₂ were tested by contaminating marble samples with ink and leaving the stones for one week outdoors. The blue colour of the ink vanished in 1 to 6 days, depending on TiO₂ precursors used.

The process for a self cleaning function may be successively or simultaneously combined with the hydrophobisation treatment described above in connection with FIG. 3. In terms of attachment to the marble stone, TiO₂ species attach to the phosphate groups that favorably attach to a marble surface. Other binding agents can be used depending on the chemical nature of the stone. For instance, for silica rich stones such as granite, SiX₄, wherein X═Cl or OR, (R=organic group of general formula CₙOₘNᵥH_{w}, e.g. —CH₃, —CH(CH₃)₂ or the like can be used to strongly attach TiO₂ to the stone.

FIG. 4 shows sections or parts of a coating, i.e. the particles 8 of a photoactive material and the organic material 10, that are exposed to sunlight or any light radiation from any light radiation source outside the article. Reference number 11 indicates exposed parts of the coating, whereas reference number 12 represents parts of the coating that are not exposed to the light radiation. As a result of the radiation, the particles 8 make active and create very reactive radical species. These radical species decompose the organic material 10 at the vicinity of the activated particles 8. Thus a surface with the self cleaning function is formed on, roughly, the areas represented by reference number 11 in FIG. 4. Any organic material or organic contamination depositing on said surface decomposes into CO₂ and H₂O or volatile intermediates. Said surface has also a hydrophilic nature because of the hydrophilic nature of the particles 8. When a strong covalent interaction exists between the particle 8 and the organic material 10, such as when phosphate or phosphonate binders are used, only the hydrophobic organic chains decompose and the surface of the particle 8 is partially covered by phosphate groups.

It is to be noted that TiO₂ particles, for instance, are usually covered by phosphate groups as phosphate is used as “glue” for enhancing adhesion to carbonates even if organophosphate is not used in treating substance at all. The outer surface of commercially available TiO₂ particles does usually comprise other substances in all cases due to impurities etc. Therefore, it is clear that the term “TiO₂ particle” does not cover only particles of 100% of TiO₂ but also those particles comprising a minor amount of other substances.

A portion of the particles 8 that is located in the unexposed part 12 of the coating inside the pores 2 is not activated by light. This part of the coating is still hydrophobic. Due to mechanical wear or corrosion of the article 1, the unexposed part 12 of the coating may be exposed to light. The particles 8 in the newly exposed part of the coating are activated by the light. As a consequence, the newly exposed part of the coating converts in to a hydrophilic and self cleaning coating, as discussed above. This way the outer surfaces of the article 1 will exhibit said self cleaning function and hydrophilic nature.

The treatment processes of introducing the self cleaning function or the hydrophobisation treatment or both may also be successively or simultaneously combined with a mechanical reinforcement process of the article 1. Such a mechanical reinforcement process means that the pores 2 of the article 1 are fully or partially filled by an inorganic material in order to decrease the pore volume and mean pore diameter of the article 1. The inorganic material may be an oxide, a carbonate, a phosphate, physical and/or chemical mixtures of these etc.

The mechanical reinforcement process may include deposition of the inorganic material onto the surfaces 7 of the pores, into the pores 2 themselves, a chemical pre-treatment of the surfaces 7 of the pores, etc.

The mechanical reinforcement process may be realized, for example, by adsorption of metallic oxide, carbonate, or phosphate compounds or their precursors or combinations or mixtures these of from solutions, by impregnation, by dip-coating, by deposition from a gas phase, and any combination of these.

Here, the term “precursor” covers any starting compound in a solid, liquid or gas form that can be converted in to a desired oxide, carbonate, or phosphate directly or by post-treatments. The term “precursor” also covers materials that originally are not in the form of oxides, carbonates or phosphates, or any combinations of two or more of these, but which can be converted in to such compounds by thermal or chemical treatments preformed particles of the desired oxide, carbonate, or phosphate also count as precursors.

The pores 2 can also be filled by inorganic-organic hybrid materials, including metal organic compounds, organometallic compounds, organically functionalized inorganic particles, inorganic particles containing organic molecules as part of their structure, mixtures of inorganic and organic compounds etc. The organic part of said hybrid materials can be, for instance, a covalently linked organic compound consisting of at least one carbon atom in its molecular structure, a physisorbed organic molecule containing at least one carbon atom in its molecular structure. The bond between the inorganic and organic portion of the hybrid material may, of course, be strong and covalent, and ionic, or weak interaction such as van der Waals type, hydrogen-bonding, co-ordination etc. or mixtures of these. The organic molecule can be incorporated into the pores 2 before or after incorporation of the inorganic portion, or together with the inorganic portion.

In an embodiment of the invention, the pores of the article 1, for instance marble, are at least partly (0.01%-99.5%) filled with silica or substance comprising silica. Then the article 1 is treated with silane by methods described in this description. As a result of this embodiment the article 1 has a hydrophobic nature or at least hydrophobic coating on its treated surfaces. It is to be noted, however, that instead of silica also other metal oxides, such as TiO₂, in their pure or mixed form may be used together with silanes. In another embodiment of the invention, the article 1 is a brick or a tile, i.e. oxide material. Pores of the oxide material are at least partly filled with a carbonate-containing substance, for instance, after which an organophosphate is bonded to the carbonate-containing substance. This way the article 1 may be hydrophobized. In addition to decreasing the pore volume and mean pore diameter of the porous matrix material, the mechanical reinforcement process may also decrease the level of total adsorption of water into the pores 2, as measured by comparing the specific mass of water that can be incorporated into the untreated matrix material 3 of the article with that of the treated material 3 under ambient conditions.

The dissolution rate of the matrix material 3 in water may also be reduced when the latter is confined to smaller pores as a result of the stronger intermolecular interaction that exists between H₂O molecules adsorbed onto a curved solid interface and because of the increasing fraction of chemisorbed substance to free water molecules. The particles 8 present inside the pores 2 decrease the effective porosity of the article 1 and potentially block at least partially some pathways for water transport into and through the article 1. It is to be noted that particles present inside the pores and decreasing the pore volume and mean pore diameter and/or reinforcing the matrix material may also comprise non-photoactive particles.

Furthermore, the mechanical properties of the article 1 may be enhanced by the presence of particles 8 inside the pores. If the pores 2 are filled up properly, mechanical properties may be improved due to cohesion enhancement. To optimize such improvement, the pores 2 may be filled with a mineral cement having strong intrinsic mechanical properties and a high chemical inertia, the cement forming strong covalent or stable coordination bonds with the surfaces 7 of the pores. It is clear that deposition of any other type of particles into the pores of the article 1 or as coatings onto the surface 7 of the pores or a combination of these can be used for decreasing the effective porosity of the article 1 and, depending on the nature of these particles or coatings, could also have a positive influence on the mechanical properties of the article 1.

In the case of CaCO₃ marble, phosphate (RO—PO₃²⁻) and phosphonate (R—PO₃²⁻) groups strongly attach to the calcium, substituting carbonate groups, and also strongly bind to any strong Lewis acid type species such as Mⁿ⁺, wherein M=Zr, Ti, Ce, Mg, Ca, Cr, Hf, Sn or Al and wherein n represents the various stable oxidation states of M, or combination of these.

Metal M salts may be dissolved in a solvent in the presence of phosphate or phosphonate groups, and potentially with silica precursors such as SiCl₄ or Si(OR)₄ wherein R=organic group of general formula CₙOₘNᵥH_{w}, preferably alkane, such as ethyl. If the solvent can wet all the surfaces 7 of the pores, the phosphate species strongly attach to the marble. Upon solvent evaporation, precipitation of the metallic oxo-phosphate occurs inside the porosity. A complete range of metallic oxo-phosphate materials can be formed between a fully metallic phosphate and a fully metallic oxide by adjusting the M/P (metal/phosphate) ratio and the proportion of various metallic inorganic precursors in the solution.

A mild thermal treatment for dehydration of the article leads to polycondensation of the metallic phosphate into solid and chemically resistant materials. An additional thermal treatment may be applied in order to increase the stability of the whole system.

Any remaining porosity may be filled up with successive cycles of a reinforcing/filling process and can eventually be treated with hydrophobic organic phosphates and/or phosphonates as described above.

Some inorganic compounds or agents may be added to the treatment substance for colouring the article 1. The article 1 is thus coloured as the treatment substance impregnates it. This can be carried out in various ways. For example, pigment particles can be adsorbed on the outer surfaces and on the surfaces of the pores, or metal ions other than Ca²⁺ may be introduced into the CaCO₃ network by ion-exchange, or an inorganic material may be precipitated from solutions containing the precursors in form of dissolved molecules, oligomers or polymers etc. or any combination of these. Deposition from a gas phase can also be performed, either by direct deposition of the metal precursors or by exposure of the impregnated article 1 containing the precursor in dissolved form to reactive gases, such as, but not limited to, NH₃, CO₂ and SOₓ.

Exposure of the dried article 1 containing colouring agent precursors or finalized coloring agents to reactive gases may also be used. Thermal treatments for increasing adhesion between the colouring agents and the surfaces of the article 1 for tuning the particle size of the colouring agents and/or for decomposing, partially or fully, the precursor into the active colouring agent form may also be used.

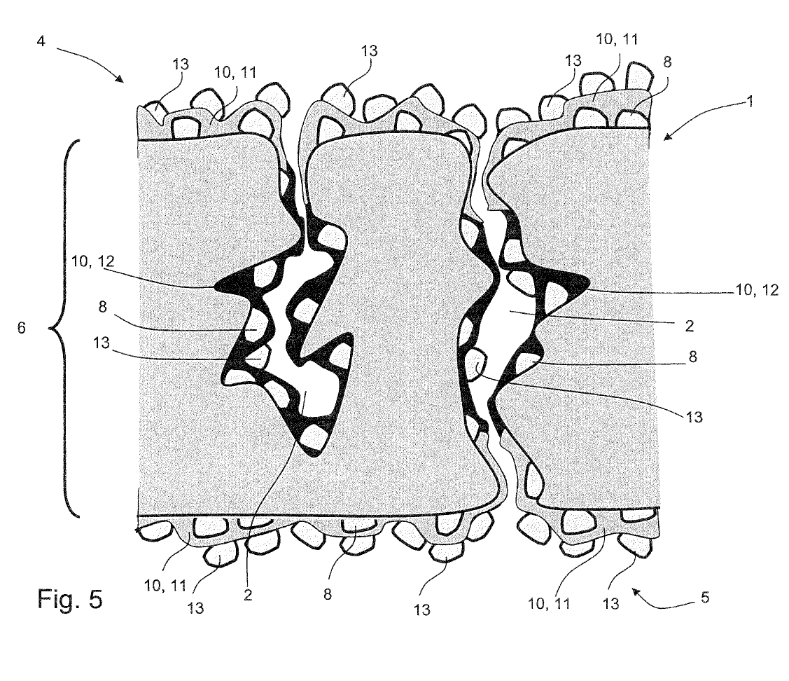

FIG. 5 is a schematic side view of the part illustrated in FIG. 1 after a fourth process step of the method according to the invention. FIG. 5 shows how an additional layer of second particles 13, for example TiO₂, has been deposited onto the article 1 by wet-methods, like spraying, dip-coating, or by other wet-chemical methods, or by a sol-gel process or deposited in pre-formed particulate form. The particles are preferably microsize or nanosize particles. These second particles 13 can also be present inside the pores of the stone.

The organic material 11 present in the outer surface 4, 5 region of the article 1 can be at least partially removed before or after the deposition of the additional layer of the second particles 13 onto at least the outer surface of the material by for example thermal methods.

A thermal treatment of at least an interfacial region between the particles 8, 13 and the matrix material 3 is also preferable in order to increase the adhesion between the particles 8, 13, such as TiO₂, and the substrate. The thermal treatment preferably increases the chemical bonding between the particles 8, 13 and the substrate and also between the particles 8, 13 themselves. However, the organic functions remain in the pores 2 of the article even after the thermal treatment, which is important in order to maintain the hydrophobic nature of the inner pores 2 of the article 1.

However, we again note that the TiO₂ layer can also be applied before organic functionalization and that the organic portion can be left on the TiO₂ and or the stone also on the outer surface if desired.

The result is thus, for example, a stone product which does not take up water and whose outer surface always stays free of organic contaminants as the active outer surface which consists of for example TiO₂ decomposes organic molecules into CO₂ or other volatile carbonaceous species under the action of UVlight provided by, for instance, sunlight and adsorbed surface water.

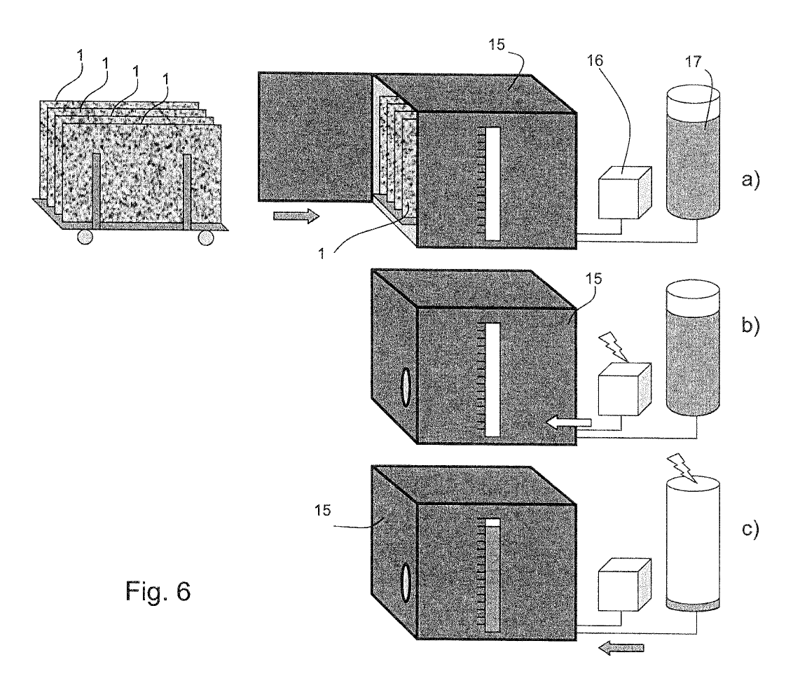

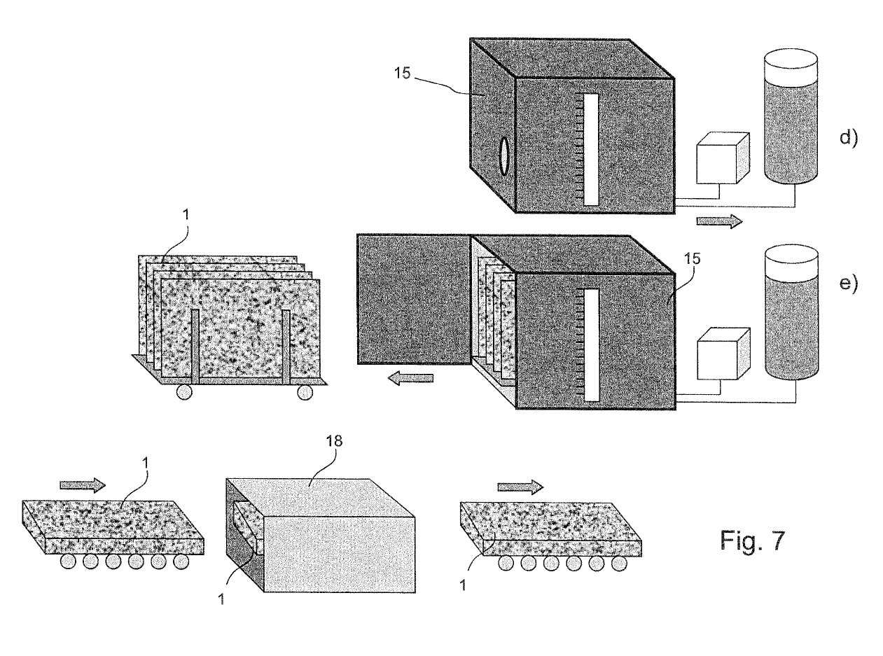

FIG. 6 is a schematic view of process steps of the method according to the invention, and FIG. 7 is a schematic view of other process steps of the method according to the invention. Articles to be treated here are sheets made of marble.

The articles 1 may be pre-treated for removing pre-adsorbed water and, if desired, crystal water from the article before further surface treatment.

The pre-treatment is an optional process step, but sometimes desirable as capillary suction processes can be used for efficient transport of the treatment substance into the pores of the article 1. Furthermore, the chemical attachment of the coating and impregnation materials to the matrix material of the article 1 can potentially be increased by at least partial removal of water from the marble before surface functionalization. The pre-treatment may be based on a heat treatment, carried out, for instance, in an induction or microwave oven, vacuum treatment or a combination thereof. In the case of thermal treatment, the articles 1 are let to cool to temperatures of about 50 to 100° C. prior to the next step.

In FIG. 6, four pre-treated articles 1 establish a batch which is arranged on a carriage 14. Naturally, the batchsize may vary. In step a) the articles 1 are arranged in a process chamber 15 and the chamber is closed. The process chamber 15 can be closed tightly so that the treatment substance does not leak out during treatment. In step b) the process chamber 15 is closed.

An optional device 16 may be a combined heating device and vacuum pump. Sometimes it may be advantageous to expose the article to a combination of thermal treatment and vacuum in order to remove at least the physisorbed water. The device 16 may also be an alcohol steam generator for first to adsorb the article 1 full of alcohol, e.g. pure ethanol, by keeping the article in a very moist alcohol steam atmosphere until all pores of the article are condensed or filled with the alcohol. Thereafter, the article 1 may be sunk into a fluorocarbon-alcohol based mixture, such as a zonyl-acohol, e.g. zonyl-ethanol, fluid. In the course of time the fluorocarbon-alcohol based fluid will exchange with the pure alcohol in the pores of the article.

In step c) the process chamber 15 is filled with a treatment substance fed from a treatment substance container 17. This is realized by a pump (not shown) or by utilizing gravity. As a result of the filling, the articles 1 are immersed in the treatment substance.

The treatment substance comprises a solvent, such as ethanol, propanol, methanol, acetone, butanol, water, 1-methoxy-2-propanol, ethylene glycol, THF (tetrahydrofuran), DMSO (dimethyl sulfoxide), cyclohexane, etc., or mixtures thereof.

Simultaneously the pores of the article 1 are becoming filled with the treatment substance. The treatment substance preferably wets all the surfaces of the pores having an open connection to the outer surface of the article 1. The treatment substance also comprises dissolved species as discussed above.

There are also alternative ways to treat the articles 1 with the treatment substance. The treatment substance may, for instance, be sprayed onto the warm articles 1, upon which the solvent at least partially evaporates. The surface of the articles 1 cool down as the solution evaporates. It is also possible to combine two or more treatment methods in a same process.

In step d) shown in FIG. 7 the process chamber 15 is emptied from the treatment substance not caught by the articles 1. This excess of the treatment substance is fed back to the treatment substance container 17. In another embodiment of the method, two process lines work in parallel and the process chambers 15 are connected to one treatment substance container 17. The processes of the two lines are synchronized so that the treatment substance is emptied from the first process chamber in the second process chamber, and vice versa. In other words, the process chamber of the first process line serves as the treatment substance container 17 of the second process line and, similarly, the process chamber of the second process line serves as the treatment substance container 17 of the first process line.

In step e) the process chamber 15 has been opened and the treated articles 1 are removed from the chamber 15. It is to be noted here that elimination of the solvent of the treatment substance from the articles 1 may be boosted in the process chamber or outside it by evaporation through reduction of the partial pressure of the solvent in the atmosphere. This can be realized by an air flux, heating and/or under-pressure so as to keep the majority of the non-volatile species of the treatment substance trapped inside the pores and/or adsorbed onto the surface of the articles 1.

According to an embodiment of the invention, the article 1 is hydrophobized using gas phase hydrophobization. In an embodiment of this process volatile precursor(s) of a hydrophobic layer are attached covalently to the surface of the porous article either as such or due to decomposition of the precursor.

Some silanes, for example, are highly hydrophobic substances and they may be vaporized in a precisely controlled manner. The hydrophobization in gas phase may be realized practically in any temperature as long as most of the free water has been removed from the article. Preferably, the process is carried out in temperature of at least 0° C., more preferably at least 40° C., most preferably at least 100° C.

In an embodiment of the invention the process of hydrophobization in gas phase, the article is arranged in a closed space. The article may, for instance, be encapsulated in by plastic film. A vaporized substance, such as silane, is arranged in the same closed space with the article. The encapsulation may be substantially gas-tight, or, alternatively, it may comprise a closable opening or a valve construction by means of which the vaporized substance may be fed into and exhausted from the encapsulation.

Providing that additional energy is needed in the course of the process, it may be brought in the process by, for instance, infra-red (IR) radiation, induction, microwave-radiation etc.

In another embodiment of the invention the process of hydrophobization in gas phase, equipment shown in FIGS. 6 and 7 may be used. Vaporized substance, for instance silane, is fed in the process chamber 15 by means of pumps or similar equipment. In another embodiment the substance is arranged in the chamber 15 prior to its vaporization, and is then vaporized by rising temperature and/or lowering pressure in the chamber 15. The article 1 is kept in the chamber 15 until a desired coating has been constituted. The article 1 may be treated by photoactive substance, such as TiO₂, either prior to the process of hydrophobization in gas phase or after said process.

Preferably, the photoactive coating layer is applied prior to gas-phase hydrophobization, but also the reverse process is possible to apply provided that the outer surface of the article is made hydrophilic prior to application of the photoactive layer by either mechanical, chemical, radiative or thermal means or by a combination of these.

Inner pressure of the chamber 15 may preferably be controlled. The pressure may be atmospheric or higher or lower than atmospheric. Even more preferably, the inner pressure may be varied during process so that pressure impulses or pressure waves are focused on the article 1. Also the partial pressure of a gaseous component of one or more gases filling the chamber 15 and composition of gas mixture may preferably be controlled and varied with.

The relative pressure of the hydrophobizing agent or hydrophobic substance shall be equal to or higher than its saturated vapor pressure at the applied conditions in order to force said substance to penetrate into the porosity of the article 1 and adsorb on the inner and outer surface thereof. Also pressures equal to the autogenic saturation pressure may be used.

The gas mixture may comprise any gas useful in the reactions and/or treatments taking place in the method of the invention, such as NH₃ and HCl. Furthermore, the humidity of the chamber 15 may preferably be controlled.

The treatment equipment may include an after-treatment means 18 for optional and additional treatments such as, but not limited to, microwave treatment, plasma treatment, thermal treatment, UV-treatment, IR-treatment, VIS-treatment, ozone treatment, laser treatment, or any combination of these. The after-treatment may be applied to transform the precursors, if any, of the functional materials into the desired form and to further reinforce cohesion of the impregnated and deposited materials by increasing the density of strong chemical bonds between the marble and the impregnated and deposited substances, and within the impregnated and deposited substances, etc. It is to be noted, however, that above-mentioned optional and additional treatments may also be carried out in the process chamber 15 for which purpose the chamber 15 is equipped with devices and means needed.

In another embodiment of the invention, the treatment substance is applied to the articles 1 by surface adsorption and/or capillary condensation from a gas phase. The gas phase may be overpressurized.

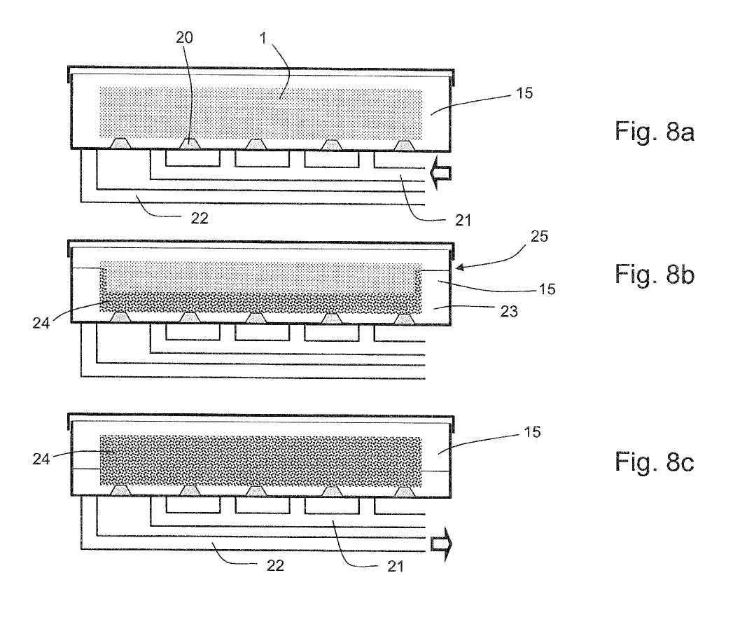

FIGS. 8a to 8c are schematic views of process steps of a second method according to the invention. FIG. 8a shows a chamber filling step of the method. An article 1 is arranged in a process chamber 15 to lie on supports 20. It is to be noted that, optionally, two or even more articles 1 may be arranged in the process chamber 15 to lie next to each other.

Feeding channels 21 are connected to the process chamber 15 for feeding the treatment substance thereto. Return channels 22 are also connected to the process chamber 15. The process chamber 15 is preferably sealed so as to minimize unwanted evaporation of the treatment substance.

FIG. 8b shows an adsorption step of the method. A treatment substance 23 is fed into the process chamber 15 such that the article 1 is immersed only partially into the treatment substance 23. The return of the treatment substance 23 through return the channels 22 is preferably prohibited.

The treatment substance 23 is entering into the article 1 in a controlled manner in order to allow the air inside the article 1 freely escape through its top surface. The already impregnated parts of the article 1 are shown by reference number 24. This way the extent of surface treatment may be increased because less air remains trapped inside the article 1. The inventors call this a directed adsorption process.

FIG. 8c shows an emptying step of the method. The feeding of the treatment substance 23 is stopped and the return channels 22 are opened in order to remove the excess of the treatment substance 23 from the process chamber 15. Next, the process chamber 15 may be opened and the treated article removed from the chamber.

The adsorption step is the most time consuming process and in order to be more efficient, this step may be performed on multiple articles 1 simultaneously. The process chamber 15 may, for instance, be construed to be stackable one on the other in order to save space needed for the adsorption step.

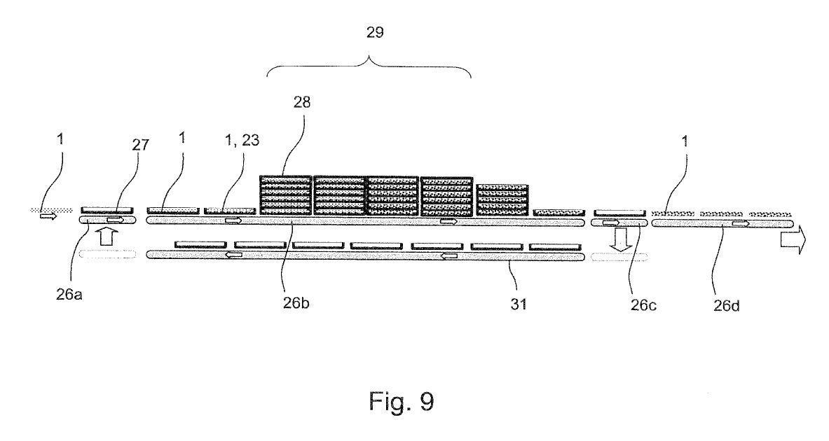

FIG. 9 is a schematic view of a process line according to the invention. Here, process chambers are arranged to serve also as transportation carriers or trays 27. A carrier 27 is for supporting and carrying at least one article 1 while the adsorption is under process. The carrier 27 is also used for providing a standard frame or module which may be handled with standardized processing means regardless of the shape and size of the article(s) 1.

At the beginning of the process the articles 1 are loaded into carriers 27. The carrier 27 is filled 82 with the treatment substance 23 in any suitable way either prior to or after the loading of the article 1.

Next, the carriers 27 are stacked into stacks 28 and transferred ahead. The stacks 28 are kept in an adsorption buffer 28 until a suitable period of time for adsorption is elapsed. The length of the suitable time for adsorption depends e.g. on the material and dimensions of the article 1. For example, less porous and thicker products need a longer time for adsorption than more porous and thinner products. The length of the suitable period of time may be discovered by experimental tests.

As the article 1 is treated it is unloaded from the carrier 23 and transferred for further processing. Empty carriers 27 may be returned to the beginning of the process line by using a return conveyor 31.

Conveyors 26a to 26d take care of the transportation of the carriers 27 in the forward direction of the process. The transportation may also be arranged by robots, manipulators or any other transportation means known per se.

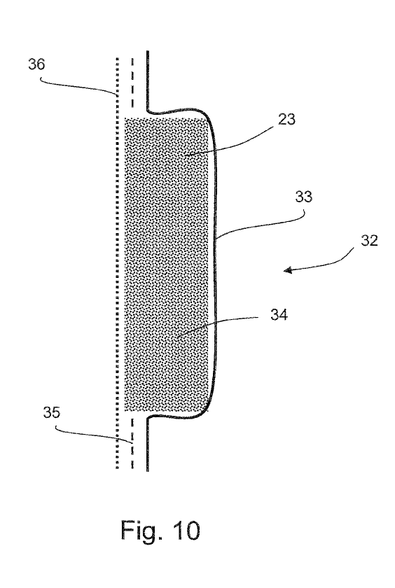

FIG. 10 is a schematic side view of a device according to the invention, shown in a cross section. The device 32 is like tape or sheet comprising an impregnation element 34 which here is a soft porous sponge or cushion which is filled with the treatment substance 23. The cushion may be made of cotton, cellulose, foamed plastics, etc. A backing film 33 preferably impermeable to the treatment substance 23 is arranged to protect the impregnation element 34. On another side of the device 32a protective film 36 is arranged which is also preferably impermeable to the treatment substance 23. The device 32 has adhesive edges 35 for attachment to a surface of an article to be treated by the treatment substance 23 and protected by the protective film 36.

The protective film 36 may be released from the adhesive edges 35 and the impregnation element 34 and, thereafter, the device 32 may be adhered to the article to be treated then. The treatment substance 23 is sucked from the impregnation element 34 by the porous article to be treated.

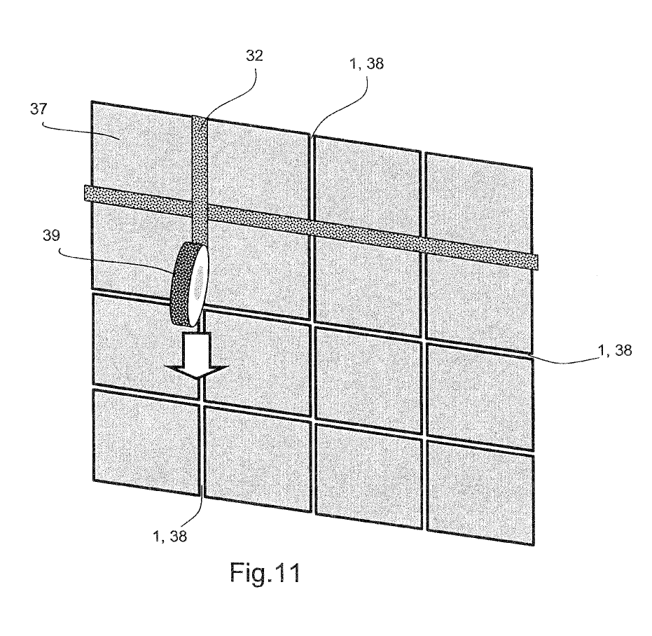

FIG. 11 is a schematic view of a third method according to the invention. The method is a post-installation process whose object is to treat seams 38 of a wall covered with ceramic tiles 37 by a treatment substance. In other words the article 1 to be treated is the seams 38 of the wall. It is to be noted that the term “post installation process” here means that the final assembly of the article has already taken place prior to its treatment. It is to be noted that the treatment may also take place during manufacture of the article, i.e. prior to the final assembly of the article.

The seams 38 are treated with a tape 32 whose structure may be similar to that of the device 32 shown in FIG. 10. The tape is unrolled from a roll 39 and mounted onto the seams 38 for an impregnation process. After a suitable time has elapsed, the tape 32 is removed. As a result the water adsorption of the seams 38 is reduced without any change in the appearance of the seams 38. In an alternative embodiment, the tape 32 contains pigments or colourants which alter the appearance of the seams 38.

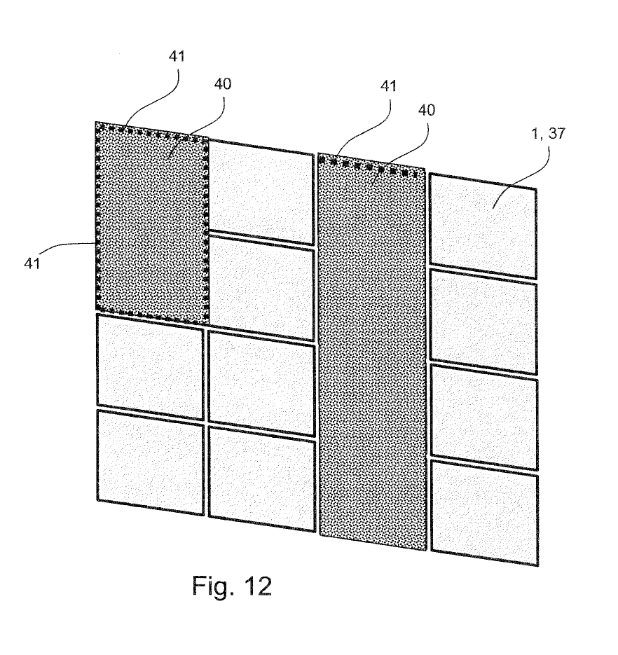

FIG. 12 is a schematic view of a fourth method according to the invention. This method is also a post-installation process where porous articles 1, here ceramic or stone tiles 37 and/or seams 38 are treated using sheets 40 whose structure may resemble that of the device described in FIG. 10. The device may have one or more adhesive edges 41 or no adhesive edges at all. The sheet 40 may contain pigments or colourants.

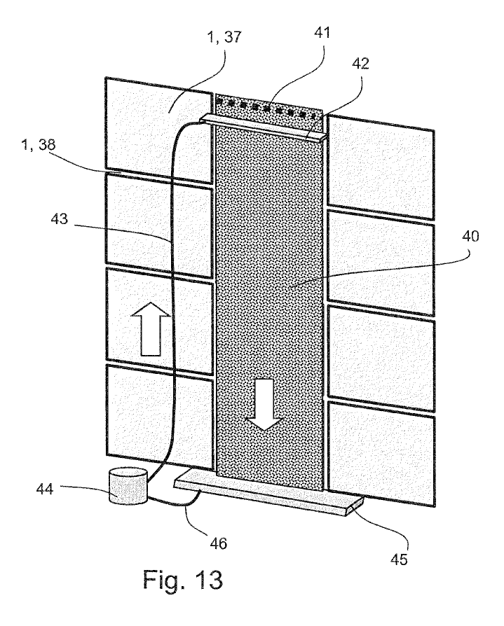

FIG. 13 is a schematic view of a second device according to the invention. A soft porous material sheet 40 is soaked with a treatment substance and attached by an adhesive 41 or held by another means to the front surface of porous articles 1 to be treated.

The sheet 40 may be e.g. a fabric and it is kept wet during the treatment by supplying a treatment substance on top of the sheet 40 by a feed channel 43. As the treatment substance flows down through the sheet 40 it is impregnated in the articles 37, 38 having contact with the sheet 40. The residual treatment substance is collected into a basin 45 and circulated back through a return channel 46 with e.g. a pump 44 to soak the material while the treatment substance transfers into said porous articles 37, 38.

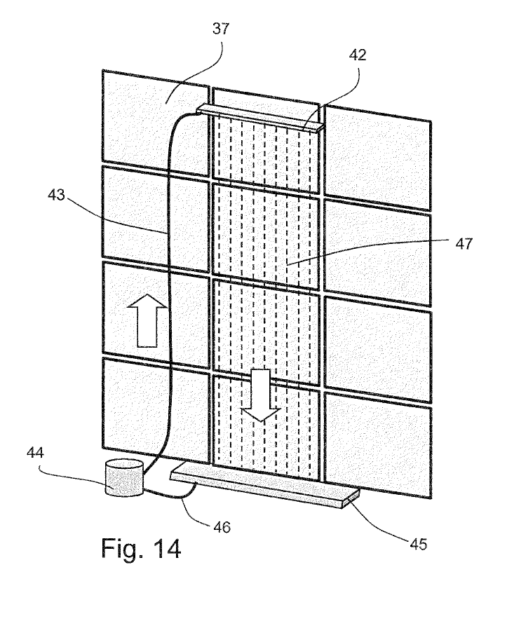

FIG. 14 is a schematic view of a third device according to the invention. The device is for a post-installation process where the front sides of the articles 37 are kept wet just by letting the treatment substance continuously pass the surface of the articles. The flow of the freely flowing treatment substance is depicted by reference number 47. The article 37 may be a marble slab covering a building wall, etc.

As the treatment substance flows down on to the front surface of the article 37, any residual fluid is collected into the basin 45 and returned to the pump 44 as described in the description of FIG. 13.

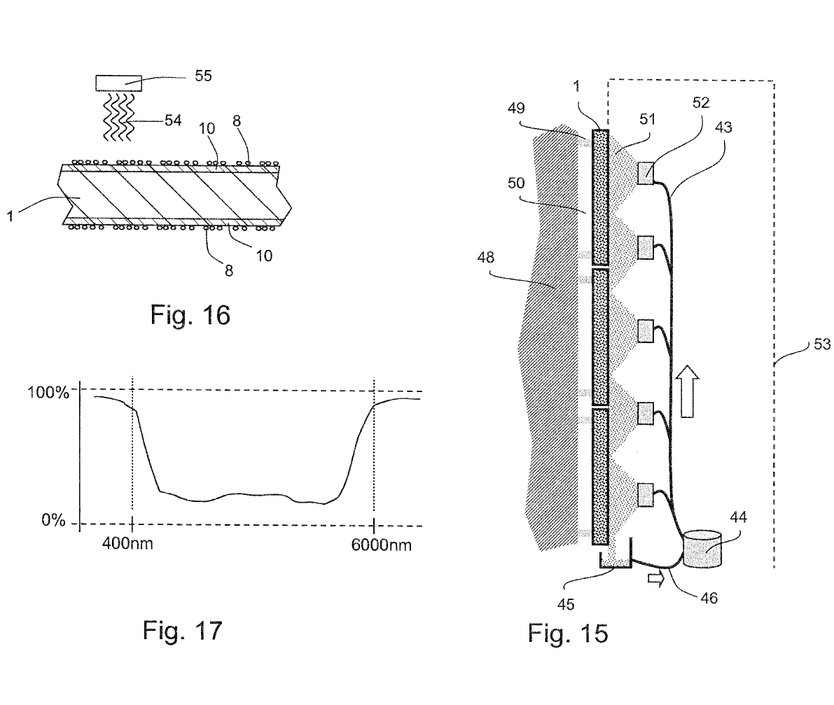

FIG. 15 is a schematic view of a fourth device according to the invention. It shows a typical wall structure where porous articles 1 are mounted to a building wall 48 with fasteners or fixtures 49, leaving an air gap 50 between the articles 1 and the wall 48. In this process the front side of the articles 1 are kept wet with one or more sprays 51, preferably very light ones, of a treatment substance generated by nozzles 52 to keep the front side of the articles 1 wet during the treatment process.

The residual treatment substance, if any, may be collected into a basin 45 and circulated back to be sprayed on to the front surface once again. To avoid unwanted evaporation and also to protect the environment from the treatment substance, the processing area can be covered and sealed with a protecting sheet or film 53.

FIG. 16 is a schematic view of a fifth method and device according to the invention. A porous article 1 is treated with a treatment substance which is applied to the article 1 by one of the methods described earlier in this description.

The porous article 1 is not impregnated from top to bottom. Instead, there are coating layers on the front and the back sides of the article 1. The total thickness of the coating layers is smaller than the thickness of the article 1. The coating layers extend into at least some of the pores open to the outer surface of the article 1 so that the thickness of the coating layer may be, for instance, some millimeters, e.g. about 5 mm. The thickness of a coating layer may be, for instance, about 0.5%, 1%, 5%, 10%, or 25% of the total thickness of the article 1. It is possible, of course, that only one of the front and the back sides is coated.

Also the end surfaces of the article 1 which are not shown in FIG. 16 may have coating layers.

The coating layer comprises particles 8 of photoactive material and organic material 10 as already described in this description. The particle 8 comprises here TiO₂, but other photoactive materials mentioned earlier may be used instead or together with TiO₂

As soon as the particles 8 have been applied to the surfaces of the article 1, they are exposed to radiation 54 which heats up TiO₂. Radiation 54 is preferably IR-radiation. Source of radiation 55 may be e.g. an IR-lamp. The particles 8 heated this way make bonds with the material of the article 1 and attach strongly to the article 1.

The wavelength of the radiation 54 is preferably selected so that it lies outside of an optical window of the material of the particles 8. FIG. 17 is showing a blocking function of a photoactive particle 8. The higher the percentage of the blocking the lower is the opacity of the material for the radiation. 100% means that all the radiation is caught by the material whereas 0% means that all the radiation is allowed to penetrate through the material. In this case the optical window lies between about wavelengths of 400 nm and 6000 nm. It is to be noted here that the wavelength range of the optical window depends on the material and may thus differ from the one shown in FIG. 17.

Selecting a wavelength of the radiation 54 which is shorter than 400 nm or longer than 6000 nm the optical window of the material of the particle 8 is avoided and most of the energy of the radiation 54 is caught by the particles 8. Thus temperature of the particles 8 rises remarkably whereas the article 1 does not heat up substantially. The heat energy needed in chemical reactions which bond the particles 8 and/or organic material 10 to the article 1 come over to the reaction site through the particles 8.

An advantage of this method is that heat stresses which could damage the material of the article 1 can be avoided. Another advantage is significant energy saving because the huge mass of the article 1 is not heated up but the tiny particles 8 only. One or more sources of radiation 55 may be arranged so that all sides of the article 1 which are to be exposed to radiation 54 can be irradiated simultaneously.

The drawings and the related description are for the purpose of illustrating the idea of the invention only. The invention may vary in detail within the scope of the claims.

1. A method of processing a porous article, said article comprising
a matrix material in a solid state and
pores therein, at least some of the pores being open to an outer surface of the article,
pretreating the article for removing pre-adsorbed water by heat treatment, vacuum treatment or combination thereof,
applying a flowing treatment substance to the outer surface of the article and into at least some of the pores,
allowing the flowing treatment substance to react with the outer surface of the article and surfaces of said at least some of the pores such that a hydrophobic coating layer is established on surfaces thereof,
removing an excess of the flowing treatment substance from the article, and
converting the hydrophobic coating layer established on the outer surface of the article into a hydrophilic coating layer.

2. The method according to claim 1, further comprising arranging a photoactive material or precursors thereof on the outer surface of the article and exposing the photoactive material to photonic radiation for converting the hydrophobic coating layer on the outer surface of the article into the hydrophilic coating layer.

3. The method as claimed in claim 2, further comprising incorporating said photoactive material into said treatment substance.

4. The method as claimed in claim 2, further comprising arranging a photoactive material on the outer surface of the article in a process step prior to the application of a flowing treatment substance to the outer surface of the article and into at least some of the pores.

5. The method as claimed in claim 2, further comprising arranging a photoactive material on the outer surface of the article in a process step after the application of a flowing treatment substance to the outer surface of the article and into at least some of the pores.

6. The method as claimed in claim 1, further comprising converting the hydrophobic coating layer established on the outer surface of the article into a hydrophilic coating layer by mechanical polishing.

7. The method as claimed in claim 1, further comprising converting the hydrophobic coating layer established on the outer surface of the article into a hydrophilic coating layer by heat treatments.

8. The method as claimed in claim 1, wherein the flowing treatment substance is a liquid comprising a volatile solvent.

9. The method as claimed in claim 8, wherein the solvent comprises ethanol, propanol, methanol, acetone, butanol, water, methoxypropanol, ethylene glycol, THF, DMSO, or cyclohexane.

10. The method as claimed in claim 1, wherein the flowing treatment substance is in a gas phase.

11. The method as claimed in claim 10, wherein the flowing treatment substance comprises silane.

12. The method as claimed in claim 2, wherein the photoactive material is a UV active and/or a Vis active material.

13. The method as claimed in claim 12, wherein the photoactive material comprises BiVO₄, TiO2, Ag-, S-, N- or P-doped TiO₂, MgTa₂O₆, ZnS, ZnO, SnO₂ or precursors thereof.

14. The method as claimed in claim 1, wherein the treatment substance comprises at least a partially organic material comprising one or more functional groups selected from phosphate, phosphonate, phosphinic acid, betadiketonate, thiol, silane, siloxane, and carboxylic acid or any salts of the corresponding acids.

15. The method as claimed in claim 14, wherein the organic material comprises an organophosphate.

16. The method as claimed in claim 1, further comprising decreasing a mean pore diameter of at least some of the pores by arranging a filler material therein.

17. The method as claimed in claim 16, wherein the filler material comprises silica, TiO₂ or other metal oxide, and that the article is treated with silane.

18. The method as claimed in claim 16, wherein the filler material comprises carbonate-containing substance, and that an organophosphate is bonded to the carbonate-containing substance.

19. The method as claimed in claim 16, wherein the filler material comprises an inorganic material, such as an oxide, carbonate or phosphate or precursors thereof.

20. The method as claimed in claim 16, further comprising converting the precursors into a porous or dense oxide, carbonate or phosphate by thermal and/or chemical treatment.

21. The method as claimed in claim 16, wherein the filler material is at least partly linked, either physically or chemically or by a combination of these, to the organic hydrophobic material.

22. The method as claimed in claim 16, wherein the filler material comprises TiO₂, SiO₂, Al₂O₃, ZrO₂, titanium or zirconium phosphate or carbonate, or a combination of these.

23. The method as claimed in claim 16, wherein the filler comprises an inorganic colouring agent, a pigment material, or precursors thereof.

24. (canceled)

25. (canceled)

26. The method as claimed in claim 1, further comprising impregnating the treatment substance in an impregnation element, contacting the porous article with the impregnation element, and letting at least some of the treatment substance migrate from the impregnation element in the porous article.

27. The method as claimed in claim 26, further comprising sealing the impregnation element by films impermeable to the treatment substance, and removing at least some of the films prior to contacting the porous article.

28. The method as claimed in claim 1, further comprising arranging the article in a closed space and hydrophobizing the article by the hydrophobizing agent or hydrophobic substance the relative pressure is equal to or higher than its saturated vapor pressure at the applied conditions.

29. (canceled)

30. The method as claimed in claim 1, wherein the matrix material is natural stone, concrete, cement, gypsum, brick, tiles ceramics, or a reactive powder.

31. The method as claimed in claim 30, wherein the natural stone is marble, granite, gneiss, limestone, sandstone, or thermal stone.

32. The method as claimed in claim 1, further comprising allowing the flowing treatment substance to react with substantially all surfaces of the pores of the article.

33. The method as claimed in any claim 14, further comprising bonding the organic hydrophobic material to the matrix material by covalent, coordination, and/or iono-covalent bonds.

34. The method as claimed in claim 1, further comprising treating an already installed article.

35. The method as claimed in claim 2, further comprising directing radiation to the coating layer, the wavelength of the radiation being selected to lie outside of an optical window of the photoactive material or precursors thereof.

36. A porous article comprising a matrix material in a solid state and pores therein, at least some of the pores being open to an outer surface of the article, wherein at least part of the outer surface of the article and at least some of the pores are treated with a coating layer comprising at least a partially organic material, the coating layer being hydrophilic on the outer surface of the article and hydrophobic in said at least some of the pores.

37. The porous article as claimed in claim 36, wherein said at least some of the pores comprise a photoactive material or precursors thereof.

38. The porous article as claimed in claim 37, wherein the photoactive material is a UV active and/or a visible light active material.

39. The porous article as claimed in claim 38, wherein the photoactive material comprises TiO₂, Ag-, S-, N- or P-doped TiO₂, MgTa₂O₆, ZnS, ZnO, SnO₂ or precursors thereof.

40. The porous article as claimed in claim 36, wherein the organic material comprises one or more functional groups selected from phosphate, phosphonate, phosphinic acid, betadiketonate, thiol, silane, siloxane, and carboxylic acid or any salts of the corresponding acids.

41. The porous article as claimed in claim 36, wherein at least some of the pores comprise a filler material, which decreases a mean pore diameter of said pores.

42. The porous article as claimed in claim 41, wherein the filler material is at least partly linked, either physically or chemically or by a combination of these, to the organic hydrophobic material.

43. The porous article as claimed in claim 42, wherein the filler material comprises TiO₂, SiO₂, Al₂O₃, ZrO₂, titanium or zirconium phosphate or carbonate, or a combination of these.

44. (canceled)

45. The porous article as claimed in claim 41, wherein the filler material comprises silica, TiO₂ or other metal oxide treated with silane.

46. The porous article as claimed in claim 41, wherein the filler material comprises carbonate-containing substance and that an organophosphate is bonded to the carbonate-containing substance.

47. The porous article as claimed in claim 36, wherein the matrix material is natural stone, concrete, cement, gypsum, tiles ceramics, or a reactive powder.

48. The porous article as claimed in claim 47, wherein the natural stone is marble, granite, gneiss, limestone, sandstone, or thermal stone.
